(19) United States
(12) Patent Application Publication
(10) Pub. No.: US 2014/0102747 A1
(43) Pub. Date: Apr. 17, 2014

(54) WIRE HARNESS

(71) Applicants: Takeshi Mizuhira, Mie (JP); Yukihiro Shirafuji, Mie (JP); Mitsuru Kurita, Mie (JP); Isamu Hamamoto, Mie (JP); Takeshi Sato, Mie (JP)

(72) Inventors: Takeshi Mizuhira, Mie (JP); Yukihiro Shirafuji, Mie (JP); Mitsuru Kurita, Mie (JP); Isamu Hamamoto, Mie (JP); Takeshi Sato, Mie (JP)

(73) Assignee: SUMITOMO WIRING SYSTEMS, LTD., Mie (JP)

(21) Appl. No.: 14/125,651

(22) PCT Filed: Apr. 2, 2012
(86) PCT No.: PCT/JP2012/058880

§ 371 Date: Dec. 12, 2013

(30) Foreign Application Priority Data
Sep. 22, 2011 (JP) 2011-207356

(51) Int. Cl. B60R 16/02

(52) U.S. Cl. CPC B60R 16/0215
USPC 174/68.3

(57) ABSTRACT

A purpose is, in the case where a nonwoven member is hot pressed around a wire harness to form a protective member, to inhibit rotation of a vehicle body fixing component attached to the protective member while making a cross-sectional shape of the protective member as circular as possible. The wire harness includes a wire harness body containing at least one electric wire and a protective member formed by hot pressing a nonwoven member in a state of covering at least a portion of the wire harness body. The protective member has a protective body that is formed to have a circular cross-sectional shape and a projection forming part that has a partially projecting part formed on an outer periphery.

### FIELD OF THE INVENTION

The present invention relates to a technology that protects a wire harness.

### BACKGROUND OF THE INVENTION

Patent Literature 1 discloses a technology for forming a protector around a flat circuit body. The protector is formed by sandwiching the flat circuit body using two covering bodies made of a nonwoven fabric thermoplastic material containing a thermoplastic felt or a foaming agent and press-molding while heating the resulting combination to firmly attach the two covering bodies to the flat circuit body and weld portions of the two covering bodies where they are in contact with each other.

### RELATED ART

### Patent Literature

### [Patent Literature 1] Japanese Patent Laid-Open Publication No. 2003-197038.

### SUMMARY OF THE INVENTION

### Problems to Be Solved by the Invention

However, usually, since a wire harness arranged in a vehicle body is formed by bundling a plurality of electric wires, the wire harness has a cross section that exhibits a circular shape. Therefore, when forming a protector to cover such a wire harness, it is preferable that the protector is formed to have a circular cross-sectional shape.

Further, when protecting a wire harness using the above protector, the protector is formed to have a shape that is bent along a wiring path of the wire harness. When assuming a case where the protector is press-molded in such a bent shape, it is preferable that the protector is formed to have a circular cross-sectional shape in order to simplify the mold configuration.

However, when the protector is formed to have a circular cross-sectional shape, in a case where a band fixing part of a vehicle body fixing component is wrapped around the protector to fix the protector, the vehicle body fixing component rotates around the protector. Therefore, in the state in which the wire harness is arranged along a predetermined wiring path, the vehicle body fixing component is not arranged in an attachment target position in the vehicle body so that an attachment operation of the vehicle body fixing component becomes difficult. Even in a state in which the vehicle body fixing component is attached to the vehicle body, there is a risk that the wire harness may rotate relative to the vehicle body fixing component and interfere with a peripheral component.

Therefore, a purpose of the present invention is, in the case where a nonwoven member is hot pressed around a wire harness to form a protective member, to inhibit rotation of a vehicle body fixing component attached to the protective member while making a cross-sectional shape of the protective member as circular as possible.

### Means for Solving the Problems

In order to achieve the above purpose, a wire harness according to a first aspect includes a wire harness body that contains at least one electric wire; and a protective member that is formed by hot pressing a nonwoven member in a state of covering at least a portion of the wire harness body and has a protective body and a projection forming part, the protective body being formed to have a circular cross-sectional shape, the projection forming part having a partially projecting part formed on an outer periphery of the projection forming part.

As a second aspect, in the wire harness according to the first aspect, a vehicle body fixing component having a band fixing part that is fixedly wrapped around the protective member and a vehicle body fixing part that can be fixed on a vehicle body is attached by fixedly wrapping the band fixing part around the projection forming part.

As a third aspect, in the wire harness according one of the first and second aspects, the projecting part is formed on a portion on one side of bisected outer periphery of the projection forming part.

As a fourth aspect, in the wire harness according any one of the first-third aspects, a plurality of projecting parts are formed on the outer periphery of the projection forming part.

As a fifth aspect, in the wire harness according any one of the first-fourth aspects, two projecting parts are continuously formed on the outer periphery of the projection forming part and a portion of a cross section of the projection forming part is formed in a rectangular shape.

### Effect of the Invention

According to the first aspect, the protective body can be formed to have a circular cross-sectional shape. Further, when the vehicle body fixing component is attached to the projection forming part, rotation of the vehicle body fixing component is inhibited by the projecting part.

According to the second aspect, by pressing the projecting part against an inner side of the band fixing part that is wrapped around the projection forming part, rotation of the vehicle body fixing component around the protective member can be inhibited.

According to the third aspect, the projecting part is formed on a portion on one side of bisected outer periphery of the projection forming part. Therefore, such a projecting part can be easily formed.

According to the fourth aspect, rotation of the vehicle body fixing component is more surely inhibited by the plurality of the projecting parts.

According to the fifth aspect, the two projecting parts are continuously formed on the outer periphery of the projection forming part and a portion of the cross section of the projection forming part is formed in a rectangular shape. Therefore, such projecting parts can be easily formed.

### BRIEF DESCRIPTION OF THE DRAWINGS

FIG. 1 illustrates a schematic perspective view of a wire harness according to an embodiment.

FIG. 2 illustrates a partial perspective view of the wire harness.

FIG. 3 illustrates a cross-sectional view along a line II-II of FIG. 2.

FIG. 4 illustrates a cross-sectional view of a state in which a vehicle body fixing component is attached to a projection forming part.

FIG. 5 illustrates an explanatory diagram of a hot-press mold.

FIG. 6 illustrates a schematic cross-sectional view along a line VI-VI of FIG. 5.

FIG. 7 illustrates a schematic cross-sectional view along a line VII-VII of FIG. 5.

### MODE FOR CARRYING OUT THE INVENTION

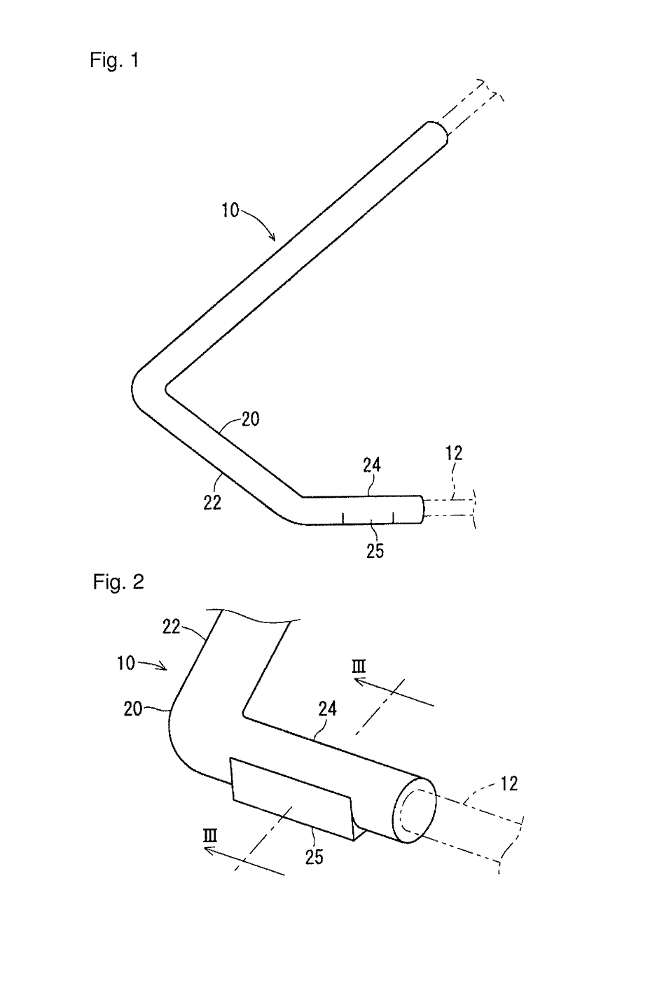

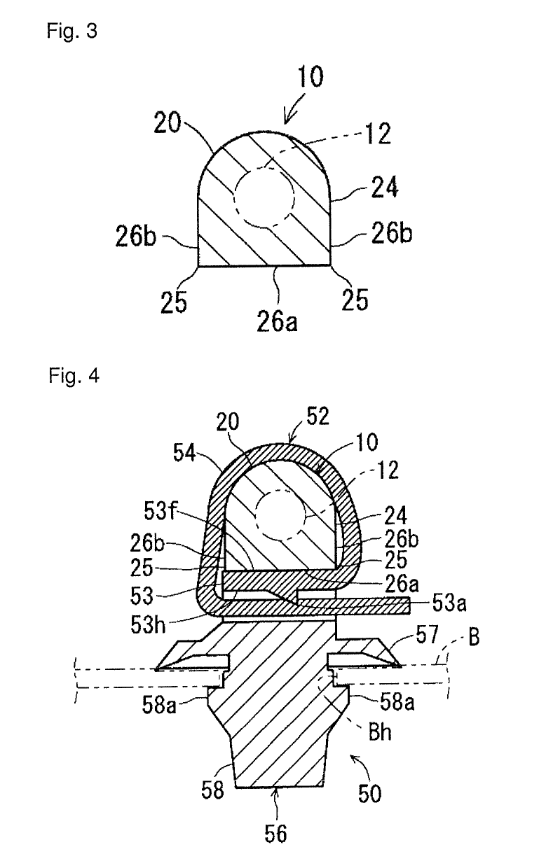

In the following, a wire harness according to an embodiment is described. FIG. 1 illustrates a schematic perspective view of a wire harness 10. FIG. 2 illustrates a partial perspective view of the wire harness 10. FIG. 3 illustrates a cross-sectional view along a line II-II of FIG. 2.

The wire harness 10 includes a wire harness body 12 and a protective member 20.

The wire harness body 12 contains at least one electric wire. Here, the wire harness body 12 is configured by bundling a plurality of electric wires along a wiring path of a vehicle to which the wire harness body 12 is to be installed. The plurality of the electric wires are usually bundled in such a manner that a cross-sectional shape of the wire harness body 12 in a plane perpendicular to a longitudinal direction of the wire harness body 12 exhibits a circular shape. The electric wires are wiring materials that electrically interconnect various electronic devices in a vehicle body and the like. An optical cable and the like may also be included in the wire harness body 12.

The protective member 20 is formed by hot pressing a nonwoven member (such as a nonwoven fabric) in a state of covering at least a portion of the wire harness body 12 in the longitudinal direction. The protective member 20 may cover substantially the entire wire harness body 12 in the longitudinal direction and may also cover a portion of the wire harness body 12.

As the nonwoven member, a material that can be hardened by being subjected to heating process can be used. As such a nonwoven member, a material containing elementary fibers and an adhesive resin (also referred to as a binder) intertwined with the elementary fibers can be used. The adhesive resin is a resin having a melting point (for example, 110° C.-115° C.) lower than that of the elementary fibers. When the nonwoven member is heated at a processing temperature lower than the melting point of the elementary fibers and higher than the melting point of the adhesive resin, the adhesive resin melts and soaks into the elementary fibers. Thereafter, when the nonwoven member is cooled to a temperature below the melting point of the adhesive resin, the adhesive resin is solidified in a state in which the elementary fibers are bound with one another. As a result, the nonwoven member becomes harder than the state before heating and is maintained at a shape molded during heating. Further, at portions of the nonwoven member that are in contact with each other, the melt adhesive resin also soaks into the contact portions and solidifies. As a result, the contact portions of the nonwoven member are bonded.

However, the elementary fiber can be any fiber that can maintain a fiber state at the melting point of the adhesive resin. Thus, in addition to resin fiber, various fibers can be used as the elementary fiber. Further, as the adhesive resin, thermoplastic resin fiber having a melting point lower than the melting point of the elementary fiber can be used. The adhesive resin may be granular or fibrous. Further, it is also possible to configure a binder fiber by forming an adhesive resin layer on outer periphery of a core fiber and use the binder fiber to intertwine with the elementary fiber. As the core fiber of this case, a fiber of the same material as the above elementary fiber can be used.

An example of the combination of the elementary fiber and the adhesive resin is using resin fiber of PET (polyethylene terephthalate) as the elementary fiber and copolymer resin of PET and PEI (polyethylene isophthalate) as the adhesive resin. In this case, the melting point of the elementary fiber is about 250° C. and the melting point of the adhesive resin is 110° C.-150° C. Therefore, when the nonwoven member is heated to a temperature of 110° C.-250° C., the adhesive resin melts and soaks into the elementary fiber that does not melt and maintains a fiber state. When the nonwoven member is cooled to a temperature below the melting point of the adhesive resin, the adhesive resin solidifies in a state in which the elementary fibers are bound with one another, and the above-described maintenance of the molded shape and the bonding of the nonwoven members are performed.

Further, the “hot press” refers to subjecting the nonwoven member to heat treatment and performing a process in which the nonwoven member is formed in a predetermined shape by being pressed against a mold. The heat treatment and the process of forming the nonwoven member in the predetermined shape may be simultaneously performed or may also be continuously and separately performed. An example of the hot press process suitable for manufacturing the protective member 20 according to this embodiment will be further described in detail below.

The protective member 20 has a protective body 22 and a projection forming part 24. The protective member 20 is formed to have an external shape corresponding to a shape of a mold when the nonwoven member is hot pressed. Therefore, by hot pressing the nonwoven member using a mold that has a mold surface corresponding desired external shapes of the protective body 22 and the projection forming part 24, the protective body 22 and the projection forming part 24 can be separately created.

The protective body 22 is a portion that constitutes most of the protective member 20 in the longitudinal direction. Here, the protective member 20 excluding the portion where the projection forming part 24 is formed is the protective body 22. A cross-sectional shape of the protective body 22 in a plane perpendicular to the longitudinal direction thereof is formed in a circular shape. Therefore, even when the protective member 20 most of which is constituted by the protective body 22 is formed in a bent shape corresponding to a wiring path of the wire harness body 12 (in particular, when the protective member 20 is formed in a three-dimensionally bent shape), an undercut place is less likely to occur. Therefore, the protective member 20 can be easily molded into a shape. Further, the wire harness body 12 is usually configured by bundling a plurality of electric wires in a manner exhibiting a circular cross-sectional shape. Therefore, when the sheet-like nonwoven member is wrapped around the wire harness body 12, an external shape of the resulting combination also has a circular cross-sectional shape. Therefore, by performing hot pressing in a manner that an external shape of the protective body 22 also exhibits a circular cross-sectional shape, processing can be performed with uniform content by making a compression degree and the like as uniform as possible on the outer periphery of the protective body 22.

The projection forming part 24 is partially provided in the longitudinal direction of the protective member 20. The projection forming part 24 may be formed to have a length dimension, in the longitudinal direction of the protective member 20, that is required for attaching a vehicle body fixing component 50 (to be described later), or to have a length dimension longer (somewhat longer) than the length dimension required for attaching the vehicle body fixing component 50.

On an outer periphery of the projection forming part 24, projecting parts 25 that partially project are formed. Here, on the outer periphery of the projection forming part 24, two projecting parts 25 are formed. Further, the two projecting parts 25 are formed on a portion on one side (lower half portion in FIG. 3) of bisected outer periphery of the above projection forming part 24. Further, the two projecting parts 25 are continuously formed on the outer periphery of the projection forming part 24, and a portion of a cross-sectional shape of the projection forming part 24 (the lower half portion in FIG. 3) is formed in a rectangular shape. More specifically, each of the projecting parts 25 is configured in such a manner that a triangular prism having a right triangular cross section is continuously provided on the outer periphery of the projection forming part 24 in an orientation in which right-angled sides of the triangular prism face outward and a longitudinal direction of the triangular prism follows along a longitudinal direction of the projection forming part 24. Further, the right-angled sides of the two projecting parts 25 are arranged in a manner being separated by a predetermined angle (90 degrees in this case) about a central axis of the projection forming part 24, and a flat surface 26a is formed between the right-angled sides of the two projecting parts 25. Further, on the outer right-angled sides of the two projecting parts 25, side surfaces 26b are formed extending toward outer peripheries of the projecting parts 25 in an orientation perpendicular to the flat surface 26a. As a result, by a portion surrounded by the flat surface 26a and the two side surfaces 26b, a rectangular shape portion is provided in a part of the cross-sectional shape of the projection forming part 24. The shape of the projection forming part 24 excluding the portion where the projecting parts 25 are formed is formed in a semi-cylindrical surface shape that is continuous to the external shape of the protective body 22.

FIG. 4 illustrates a cross-sectional view of a state in which the vehicle body fixing component 50 is attached to the above projection forming part 24.

The vehicle body fixing component 50 has a band fixing part 52 and a vehicle body fixing part 56 and is a component integrally molded with resin.

The band fixing part 52 has a base part 53 and a band part 54 that extends from the base part 53. An insertion hole 53h capable of allowing the band part 54 to be inserted thereinto is formed on the base part 53. An engaging projection 53a is formed inside the insertion hole 53h. Further, an outward surface of the base part 53 is formed as a flat surface 53f. The band part 54 is formed in a bendable band shape having a length dimension that allows the band part 54 to be wrapped around the projection forming part 24. A plurality of ridges (not illustrated in the drawings) capable of engaging with the above engaging projection 53a are formed on one principal surface of the band part 54 along a longitudinal direction of the band part 54.

Further, the vehicle body fixing part 56 is integrally formed on an opposite side of the surface 53f of the base part 53 and has a dish-shaped part 57 and an engaging lock part 58. The dish-shaped part 57 is formed in a dish shape that gradually spreads toward an engaging lock part 58 side. Further, the engaging lock part 58 is protrusively formed on a central part on an inner side of the dish-shaped part 57. The retaining projection 58a is formed at a position a predetermined distance away from the dish-shaped part 57. The retaining projection 58a is a member elastically deformable in an inward-outward direction and is simplistically illustrated in FIG. 4.

The present vehicle body fixing component 50 is fixedly attached to the projection forming part 24 as follows. That is, in a state in which the flat surface 26a of the projecting parts 25 is pressed against the surface 53f of the base part 53, the band part 54 is wrapped around the projection forming part 24 and a front end portion of the band part 54 is inserted through the insertion hole 53h. Then, the band part 54 that protrudes from the insertion hole 53h is pulled to tighten the band part 54 around the projection forming part 24. In the state in which the band part 54 is tightened, the retaining projection 58a engages with the ridges of the band part 54 and the tightened state is maintained. In this state, the projecting parts 25 are pressed against inner peripheral portions of the band fixing part 52 wrapped around the projection forming part 24 in a manner that the flat surface 26a is pressed against the surface 53f of the base part 53. Therefore, rotation of the band fixing part 52 around the projection forming part 24 is inhibited.

It is not necessary that the projecting parts 25 are at the above-described positions. For example, even when the projecting parts 25 are pressed against a middle portion of the band part 54 in a longitudinal direction, the projecting parts 25 formed on a portion of the periphery of the projection forming part 24 is strongly pressed against the inner periphery of the band part 54 and thereby the rotation of the band fixing part 52 is inhibited.

As described above, in the state in which the band fixing part 52 is fixedly attached to the projection forming part 24, when the engaging lock part 58 is pushed into an attaching hole Bh formed on a vehicle body B to bring the dish-shaped part 57 into contact with the vehicle body B and to retain and engage the retaining projection 58a with the attaching hole Bh, the vehicle body fixing part 56 is fixedly attached to the vehicle body B. In this way, the wire harness 10 is attached to the vehicle body B via the vehicle body fixing component 50.

Next, a method manufacturing the above protective member 20 using a hot press is described.

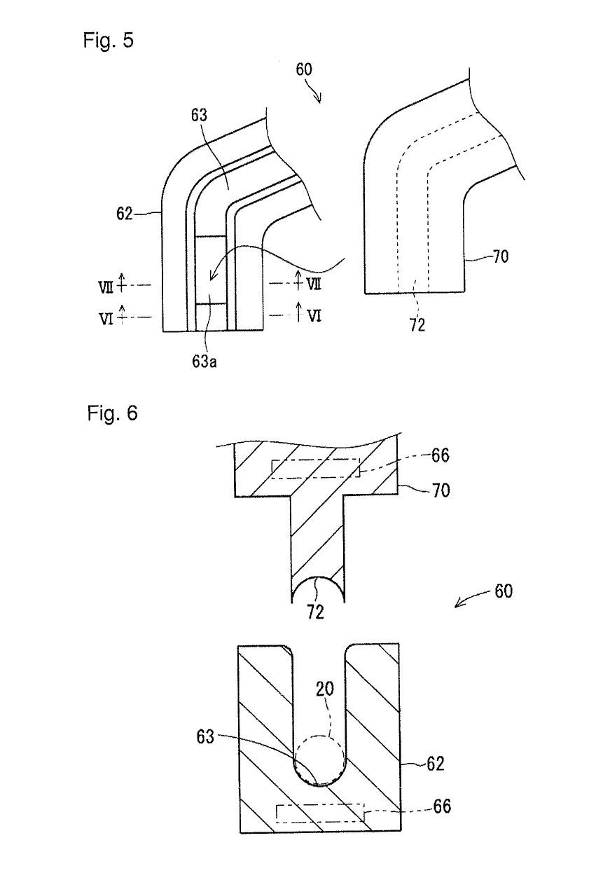

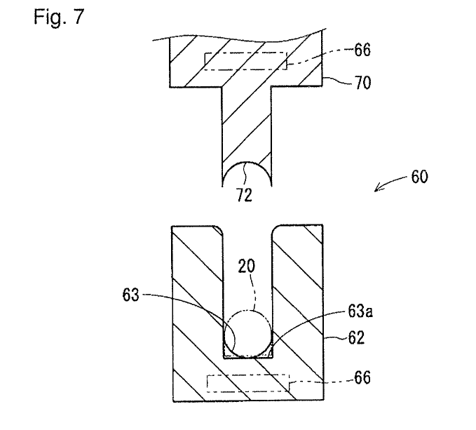

First, an example of a configuration of a hot-press mold used in manufacturing the protective member 20 is described. FIG. 5 illustrates an explanatory diagram of a hot-press mold 60. FIG. 6 illustrates a schematic cross-sectional view along a line VI-VI of FIG. 5. FIG. 7 illustrates a schematic cross-sectional view along a line VII-VII of FIG. 5.

The hot-press mold 60 is provided with a lower mold 62 and an upper mold 70.

The lower mold 62 is a long member formed of a metal and the like having excellent thermal conductivity. A lower mold surface 63 is formed on one principal surface (upper surface) of the lower mold 62. Schematically, the lower mold surface 63 is formed in a groove shape that opens upward and on both end sides. The lower mold surface 63 is formed to have a length in a longitudinal direction that is substantially the same as a length of a to-be-protected portion of the wire harness body 12 (portion to be covered by the protective member 20). Further, the lower mold surface 63 is formed in a shape that extends while bending in accordance with a path in a case where the to-be-protected portion of the wire harness body 12 is arranged in a vehicle body (only a portion is illustrated in FIG. 5).

Further, a bottom part of a portion of the lower mold surface 63 that corresponds to the protective body 22 is formed to have a semi-circular cross-sectional shape. In other words, the portion of the lower mold surface 63 that corresponds to the protective body 22 is formed to have a shape in which a semi-circular groove is continuously formed below a portion that opens with a uniform width. Further, a bottom part of a portion of the lower mold surface 63 that corresponds to the projection forming part 24 is formed to have a rectangular cross-sectional shape. In other words, the portion of the lower mold surface 63 that corresponds to the protective body 22 is formed as a recess 63a having a rectangular cuboid shape.

The upper mold 70 is a long member formed of a metal and the like having excellent thermal conductivity. On one principal surface (lower surface) of the upper mold 70, an upper mold surface 72 is formed in a groove shape having an arc-shaped cross section. The upper mold surface 72 is formed to have a width that allows the upper mold surface 72 to be arranged inside the lower mold surface 63 while allowing the upper opening of the above lower mold surface 63 to be closed. Further, the upper mold surface 72 is formed in a shape that extends while bending in accordance with a bending shape of the above lower mold surface 63.

By arranging the upper mold surface 72 inside the lower mold surface 63, a space that allows the protective member 20 to be formed is formed between the upper mold surface 72 and the lower mold surface 63. A heating mechanism 66 such a heater is provided in each of the lower mold 62 and the upper mold 70.

Next, a method manufacturing the protective member 20 using the above hot-press mold 60 is described.

First, a to-be-protected portion of the wire harness body 12 containing at least one electric wire is covered by a nonwoven member. As an embodiment of covering around the wire harness body 12 with a nonwoven member, for example, a configuration can be adopted in which a sheet-like nonwoven member (nonwoven fabric) is formed in a rectangular shape and the rectangular nonwoven member is wrapped at least once around the wire harness body 12, or a configuration can be adopted in which a sheet-like nonwoven member (nonwoven fabric) is formed in a band-like shape and the band-like nonwoven member is spirally wrapped around the wire harness body 12.

Next, the nonwoven member covering the wire harness body 12 is arranged inside the lower mold surface 63 of the lower mold 62.

Thereafter, the upper mold surface 72 of the upper mold 70 is inserted into the lower mold surface 63. In this state, the nonwoven member is hot pressed inside the hot-press mold 60. That is, in a state in which the nonwoven member is pressed between the lower mold surface 63 and the upper mold surface 72, the nonwoven member is heated. Thereafter, when the nonwoven member is cooled, a surface of the nonwoven member is cured in a shape corresponding to the shapes of the lower mold surface 63 and the upper mold surface 72. That is, the protective member 20 is cured in a shape in a longitudinal direction corresponding to the bending shapes of the lower mold surface 63 and the upper mold surface 72. Further, the surface of the protective member 20 is cured in a shape in which the protective body 22 is formed and in a shape in which the projection forming part 24 is formed, and is maintained in a predetermined shape. Further, contact portions of the nonwoven member are bonded and a state in which the wire harness body 12 is covered is maintained.

According to the wire harness 10 configured as described above, the protective body 22 can be formed to have a circular cross-sectional shape. As a result, even in the case where the wire harness body 12 is formed in a bent shape according to a wiring path, when the protective member 20 is molded using the hot-press mold 60 and the like, an undercut portion is less likely to occur and thus the protective member 20 can be easily molded. Further, the outer periphery of the protective body 22 can be made in a uniform state by making a compression degree and the like as uniform as possible.

Further, when the vehicle body fixing component 50 is attached to the projection forming part 24, the projecting parts 25 are pressed against an inner peripheral surface of the band fixing part 52. Therefore, rotation of the vehicle body fixing component 50 around the projection forming part 24 is inhibited. As a result, in a state in which the wire harness 10 is arranged along a predetermined wiring path in a vehicle body, the vehicle body fixing part 56 of the vehicle body fixing component 50 can be more accurately arranged in the attaching hole Bh that is an attachment target position, and the operation of attaching the vehicle body fixing component 50 to the vehicle body B can be easily performed. Further, in the state in which the vehicle body fixing component 50 is attached to the vehicle body B, the wire harness body 12 becomes difficult to rotate relative to the vehicle body fixing component 50, and the wire harness body 12 can be more surely maintained in a constant orientation. Therefore, the wire harness body 12 is less likely to interfere with a peripheral component.

Further, the projecting parts 25 are formed on a portion on one side of bisected outer periphery of the projection forming part 24. Therefore, in the case where the projection forming part 24 is formed using the hot-press mold 60 that has the lower mold 62 and the upper mold surface 72 as described above, a mold surface for forming the projecting parts 25 may be formed on a mold on one side (here, the lower mold 62) and a mold surface for forming the other portion of the projection forming part 24 may be formed as a mold surface similar to that for the protective body 22. For example, a groove having a semi-circular portion may be formed on each of both the lower mold 62 and the upper mold surface 72 and the recess 63a for forming the above projecting parts 25 may be formed only on one of the lower mold 62 and the upper mold surface 72. Therefore, the hot-press mold 60 can be easily manufactured and the projection forming part 24 can be easily formed.

The projecting parts may also be formed on portions on both sides of bisected outer periphery of the projection forming part. In this case, recesses for forming the projecting parts may be formed on both the lower mold surface and the upper mold surface.

Further, a plurality of the projecting parts 25 are provided. Therefore, by pressing each of the projecting parts 25 against the inner peripheral surface of the band fixing part 52, rotation of the vehicle body fixing component 50 can be more surely inhibited.

Of course, there may be one or three or more projecting parts. When a plurality of projecting parts are provided, the plurality of the projecting parts are not required to be mutually continuous as described above. Further, when a plurality of projecting parts are provided, it is preferable that the plurality of the projecting parts are formed on a portion on one side of bisected outer periphery of the projection forming part.

In particular, the two projecting parts 25 are continuously formed on the outer periphery of the projection forming part 24, and a portion of the cross-sectional shape of the projection forming part 24 is formed in a rectangular shape. Therefore, in the hot-press mold 60, the recess 63a having a rectangular cuboid shape for forming the projection forming part 24 may be formed. Therefore, such a hot-press mold 60 can be easily molded and such projecting parts 25 can be easily formed.

Further, by pressing the flat surface 26a between the two projecting parts 25 against the flat surface 53f of the inner periphery of the band fixing part 52, rotation of the vehicle body fixing component 50 can be more surely inhibited.

The shape of the above projecting parts 25 is not limited to that of the above example. The projecting parts may have a prismatic shape, a semi-cylindrical shape and the like.

The configurations described in the above embodiments and modified embodiments can be combined as appropriate as far as they do not contradict each other.

In the above, the present invention is described in detail. However, the above description in all aspects is for exemplary purposes and the present invention is not limited by the description. Numerous modified embodiments that are not exemplified can be envisioned without departing from the scope of the present invention.

1. A wire harness comprising:
a wire harness body that contains at least one electric wire; and
a protective member formed by hot pressing a nonwoven member covering at least a portion of the wire harness body, the protective member including a protective body and a projection forming part, the protective body being formed to have a circular cross-sectional shape, the projection forming part having a partially projecting part formed on an outer periphery of the projection forming part.

2. The wire harness according to claim 1, wherein
a vehicle body fixing component having a band fixing part fixedly wrapped around the protective member and a vehicle body fixing part configured to be fixed on a vehicle body, is attached by fixedly wrapping the band fixing part around the projection forming part.

3. The wire harness according claim 1, wherein
the projecting part is formed on a portion on one side of bisected outer periphery of the projection forming part.

4. The wire harness according claim 1, wherein
a plurality of projecting parts are formed on the outer periphery of the projection forming part.

5. The wire harness according claim 1, wherein
two projecting parts are continuously formed on the outer periphery of the projection forming part and a portion of a cross section of the projection forming part is formed in a rectangular shape.
